(19) United States
(12) Patent Application Publication
(10) Pub. No.: US 2020/0154714 A1
(43) Pub. Date: May 21, 2020

(54) ANTI MICROBIAL PANELS

(71) Applicant: Canine Professional Services, Inc., Westlake, OH (US)

(72) Inventor: George W Booth, Westlake, OH (US)

(73) Assignee: Canine Professional Services, Inc., Westlake, OH (US)

(21) Appl. No.: 16/688,758

(22) Filed: Nov. 19, 2019

Related U.S. Application Data
(60) Provisional application No. 62/770,131, filed on Nov. 20, 2018.

(51) Int. Cl. A01N 59/20; B32B 5/18; B32B 15/20; B32B 15/04; B32B 7/12; B32B 7/08; B32B 3/08; A01N 25/34

(52) U.S. Cl. CPC A01N 59/20; B32B 5/18; B32B 15/20; B32B 15/046; B32B 7/12; B32B 2266/0228; B32B 3/08; A01N 25/34; B32B 2419/04; B32B 2266/0278; B32B 7/08

(57) ABSTRACT

An anti-microbial panel having an antimicrobial layer, a lightweight core layer, and a structural layer. The anti-microbial layer is preferably comprised of an anti-microbial substance such as a copper, silver, or bamboo screen, for example. The panel is configured for installing on a wall or ceiling such that one or more of said panels kills microbes in a room by microbes contacting the anti-microbial layer via air flow, for example. The panel may be made decorative by embossing or providing other decorative features.

### CROSS-REFERENCES To RELATED APPLICATIONS

This application claims the benefit of U.S. provisional application Ser. No. 62/770,131 filed on Nov. 20, 2018, incorporated herein by reference in its entirety.

### BACKGROUND

Infectious agents can be common in many health care facilities, whether such facilities are for the treatment of humans, or other animals. The infectious agents, such as viruses, molds, yeasts, bacteria, and other contagions are often spread by air flow. Current forms of disease prevention include the use of toxic chemicals, expensive UV lighting, and cost prohibitive air purifiers and filters. A replacement or a supplement of existing methods of costly air purification methods with a simple to install and maintain static device, while leaving a reduced carbon footprint, is desirable. Additional means of killing contagious agents in a cost-effective manner is hence desired.

### SUMMARY

Provided are a plurality of example embodiments, including, but not limited to, am anti-microbial panel comprising: a structural layer; and an anti-microbial layer. The structural layer and the anti-microbial layer are formed into a panel, and the panel is configured to the installed on a wall or ceiling of a room with the anti-microbial layer exposed to an interior of the room and the structural layer affixed to the wall or ceiling.

Also provided is an anti-microbial panel comprising: a structural layer; an inner core layer comprised of a lightweight polymer affixed to the structural layer; an anti-microbial layer affixed to the inner core layer; and a frame part. The structural layer, the inner core layer, and the anti-microbial layer are formed into a panel, and the frame part is configured to encompass the perimeter of the panel. The panel is configured to the installed on a wall or ceiling of a room with the anti-microbial layer exposed to an interior of the room and the structural layer affixed to the wall or ceiling.

Further provided is a method of killing microbes in a room comprising the steps of:
providing an anti-microbial panel comprising: a structural layer, an inner core layer comprised of a lightweight polymer affixed to the structural layer, and an anti-microbial layer affixed to the inner core layer, such that the structural layer, the inner core layer, and the anti-microbial layer are formed into a panel;
installing a plurality of the panels in a room on a wall, a ceiling, or both; and
killing microbes in the room when the microbes come into contact the anti-microbial layer through air flow in the room.

Still further provided are any of the above panels where the anti-microbial layer is comprised of an uncoated copper screen, where the anti-microbial layer is embossed with an image, and/or where the inner core layer is comprised of a urethane or polystyrene foam.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 shows a schematic of a multi-layer breakdown of the individual components of an example embodiment of the wall mounted panel;

FIG. 1A shows a schematic of a multi-layer breakdown of the individual components of another embodiment of the wall mounted panel;

FIG. 2 shows a schematic of a top down multi-layer view of the individual components of an example embodiment of a drop ceiling panel;

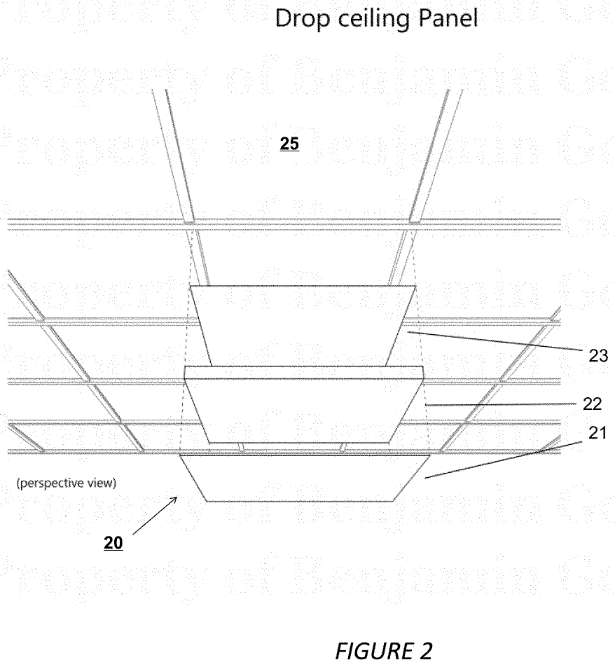

FIG. 2A shows another view of the schematic of a top down multi-layer view of the individual components of an example embodiment of a drop ceiling panel including a frame part;

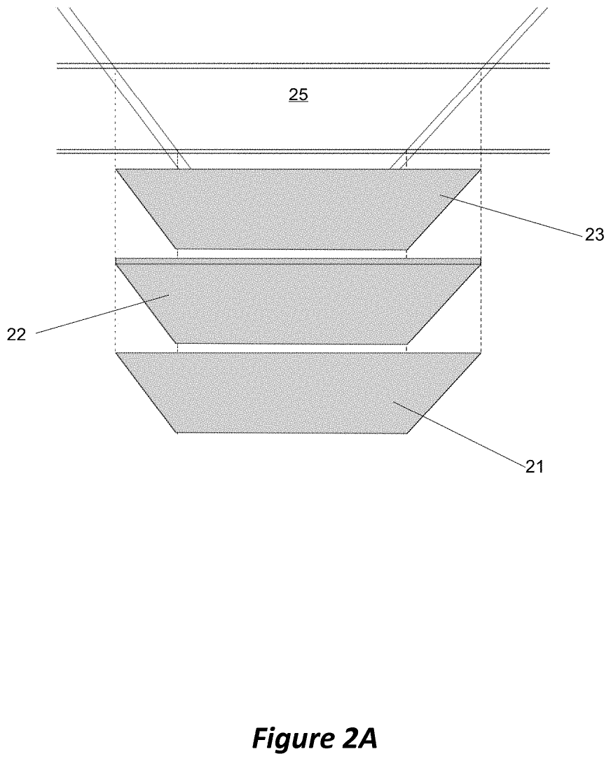

FIG. 3 shows a schematic of a side-cut view with example dimensions of a frame used in the example embodiment of FIG. 1A; and

FIG. 4 shows an example view of another example embodiment of a wall mounted panel with a frame part having a decorative embossment provided thereon.

### DETAILED DESCRIPTION OF THE EXAMPLE EMBODIMENTS

Described herein are various example embodiments of anti-microbial panels for use in killing microbes in a room or facility, such as a living space, a hospital, a kennel or doctor's or veterinarian's office, for example.

An example purpose of the anti-microbial panels, which may also be sound reducing panels, is to improve the quality of life of its user and other interested parties by eliminating the most common types of airborne bacteria and viruses on contact and to reduce the ambient noise common in enclosed dwellings and public spaces while reducing the carbon footprint of the user. The anti-microbial sound reducing panel or cartridge addresses public safety concerns with the spread of airborne viruses, bacteria and many other airborne contagions while also reducing the ambient noise levels in public enclosed spaces.

The anti-microbial sound reducing panel as described herein is designed to kill, not capture, various airborne bacteria, contagions, and viruses on contact. Current technologies typically require large amounts of electricity to purify air through UV lighting, chemical treatment, or HEPA (High Efficiency Particulate Air) filtering requiring regular replacement and forced air to function, or they may require the use of hazardous chemicals and/or sanitizing agents.

For example, example panels can be used in animal kennels, grooming salons, veterinary offices or other public places preventing the spread of the Bordetella Virus as shown by ASTM E 2180 testing completed on Oct. 29, 2018, that showed a 99.453% reduction in the Bordetella bronchiseptica virus in 1 hour and a >99.99% reduction when tested again at 6 hours.

The device can also be utilized in public gathering places susceptible to larger than normal exposure to airborne viruses and bacteria such as nursing homes, schools, office buildings, hospitals and public places where airborne illness generally spreads. Even individual homes could use the panels to reduce microbe spread and infections.

Some of the example benefits of the anti-microbial panel includes an aesthetically pleasing wall or ceiling mounted panel that may be embossed or stamped with a custom logo or design using a concave stamping process provided by 3D image printing or resin printers, that requires no electricity, little to no maintenance, nor toxic or nauseous chemical application and can be installed on existing surfaces or ceiling devices with little to no technical skill.

The panels may also provide sound reducing or deadening functions. The anti-microbial panel will effectively eliminate an effective amount of airborne contagion, actually increasing its effectiveness with the greater public traffic circulating the air, creating a significant public health benefit. The antimicrobial quality of a soft metal mesh or fabric layer, perhaps along with additional sound reducing materials such as disclosed herein, can reduce ambient noise in a closed environment by many factors depending on the quantity and type of surface applied to the panel. Dog Kennels and grooming salons specifically are well over the OSHA standards reaching levels of 110 decibels. 140 decibels is considered painful. Other public buildings could also utilized the sound reducing benefits of example panels, although in many situations, panels that do not effectively reduce sound levels might also be used, such as in some theaters or other public venues, or in homes or offices where sound reduction is not desirable.

An anti-microbial device made from a semi permeable multi layered panel or cartridge comprising an anti-microbial layer that may include a metallic alloy mesh or fabric mesh as outer surface shell, which may comprise materials having anti-microbial properties such as; silver, copper, bamboo or hemp. Aesthetically, the outer membrane may be embossed or stamped with a custom design or logo. An inner core may optionally be provided to add additional sound-absorption, comprising a material such as a urethane or polystyrene membrane or padding that may be saturated with an anti-microbial agent to add additional anti-microbial properties. Additionally, a rigid fire resistant chipboard or cardboard backing may be provided to add strength and structure to the resulting laminated panel. Additionally, framing the panel in a rigid channel framing using abs, plastic, wood, composite or metal provides an added layer of structural rigidity. The resulting panel can be used as a static wall mounted device, or may be installed as a dropped or hanging panel, or as part of a stand-along wall divider, any of which are meant to kill, not capture, various airborne bacteria and viruses upon physical contact. The panel utilizes forced or natural air circulation to increase potential contact with the microbes in a closed environment, such as an office, animal kennel, warehouse, school, hospital, nursing home, residence, or any location where airborne viruses or bacteria present a risk to the general public or animal species or others.

Figure One (1) shows an exploded perspective view of a wall mounted panel comprising, for example, three layers. An outer anti-microbial surface layer 11 is provided comprising copper, silver, hemp or bamboo mesh, screen, cloth, or other layer. In particular, a copper mesh layer has been shown to have anti-microbial properties when the copper mesh is uncoated and fully exposed. Other materials may alternatively also provide anti-microbial properties, such as silver, for example, but copper has been shown to have good antiseptic properties at a reasonable cost with slow reduction in such properties due to corrosion.

An inner core layer 12 of a support and/or sound-absorbing material, such as urethane or polystyrene foam which can optionally be chemically treated or saturated with an anti-microbial agent, depending on its intended use, is provided for structure and body. This inner core layer 12 can be decorative, such as by providing color or patterns, or even a sculptured surface. Alternative materials, such as Styrofoam, plastic, wood, or other materials could be utilized as an alternative or addition. If a sufficiently strong material is used, the third layer described below may be unnecessary.

A rigid backing 13 comprised of fire resistant chipboard or cardboard or wood is also provided to add strength and additional structure to the resulting panel. Note that these panels could be used to panel entire walls, or just as decorative and functional hangings that are strategically placed throughout the room in a manner similar to paintings or other wall hangings. A hanging wire 14 can be provided on the back of the panel, if desired.

These layers can be laminated to each other using an adhesive such as a glue or by using fasteners as described in more detail hereinbelow.

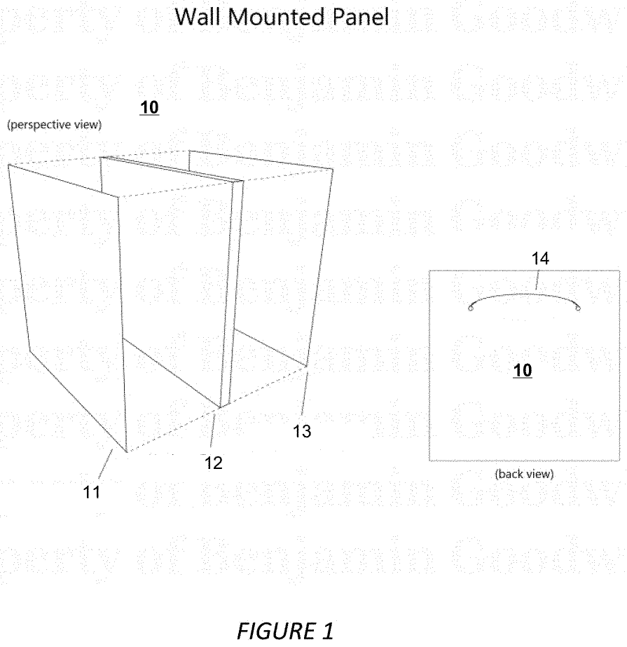

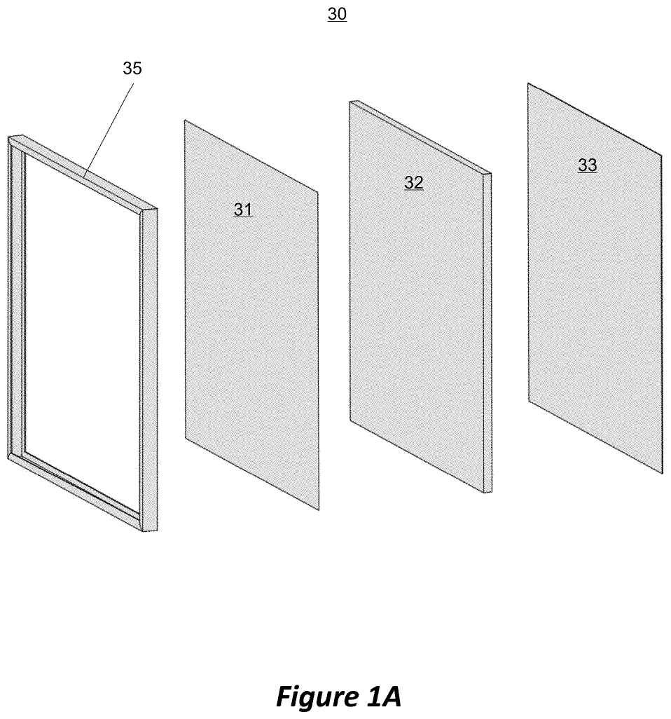

FIG. 1A shows another example embodiment of a wall panel 30 having an inner core layer 32, a rigid backing layer 33, and an outer anti-microbial surface layer 31, such as described above, but also including a frame part 35 configured to surround an outer edge of the layers 31, 32, and 33.

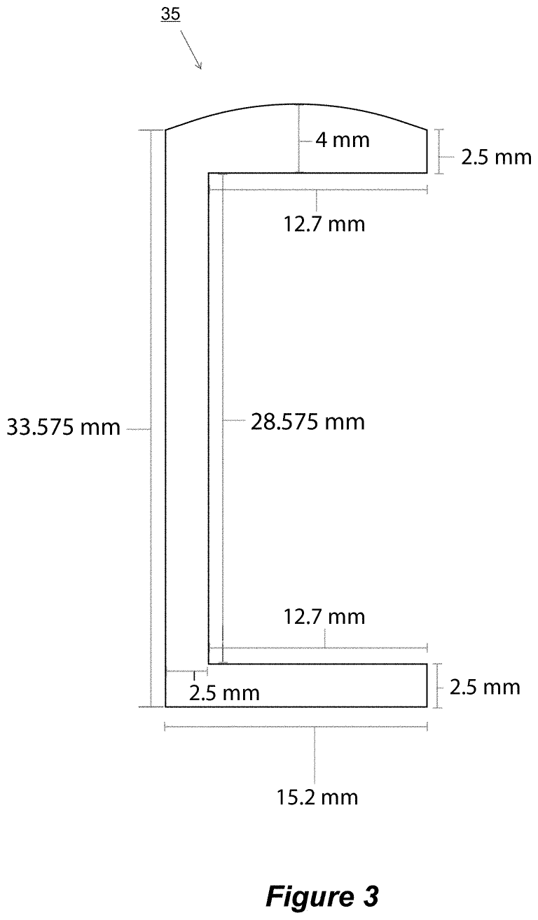

FIG. 3 shows a side cut view of the frame part 35, that is used in the wall panel 30, and which represents modification of the panel 10 of FIG. 1 including an additional frame part 35 that surrounds an outer perimeter of the panel. This frame part 35 provides both structural and decorative features, and can be arranged as a channel framing which can be comprised of wood, metal, composite or polymer such as ABS plastic providing structural rigidity and used to hold the core materials layers 31, 32, and 33 together, rather than, or in addition to, using an adhesive or other connector to laminate the layers together. This component 35 can be utilized to support common wall-hanging techniques.

Figure Two (2) and Two-A (2A) show perspective views of a panel 20 used as a ceiling dropped panel in a ceiling 25 comprising three layers similar as described hereinabove. An outer antimicrobial surface layer 21 is provided comprising copper, silver, hemp or bamboo screen, cloth, or other layer. An inner core layer 22 of urethane or polystyrene foam is provided, which can be chemically treated or saturated with an anti-microbial agent or fire preventive agent, depending on its intended use, and which may provide sound-absorbing properties. A rigid backing 23 comprised of a fire resistant chipboard or cardboard also provided to add strength and structure to the resulting panel. Ceiling panels can be designed as to fit the most common drop ceiling frameworks, and are particularly beneficial if they are made lightweight. Note that the ceiling panels 20 could also use a framing part as described above for the wall panels 10.

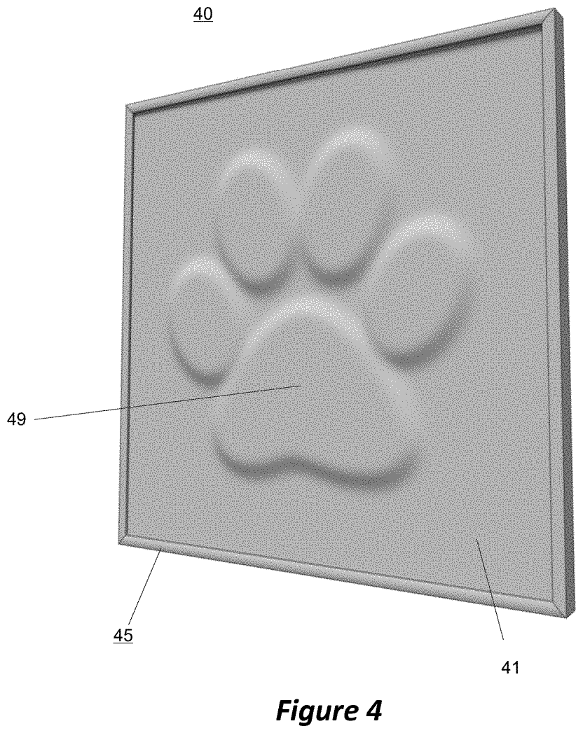

Other panel designs utilizing these features could also be provided, including the addition of decorative features. For example, FIG. 4 shows an example wall panel 40 that has an outer anti-microbial surface layer 41 that is embossed 49 with an image, in this case of a paw print, for decorative purposes. This embodiment is shown with a frame part 45.

Embossing of the panel is done through a manual transmission of a 3D pattern, template or “plate” created using any large scale commercially available 3D printer. A logo, picture or design is created using CAD (computer assisted drawing) software to create a three dimensional image or the artwork and then core which is comprised of the copper, foam and chipboard is pressed with sufficient weight and force to create a concave image of the 3d printed plate upon the panel, thus giving the design or artwork a permanent indentation upon the panel. The image is typically transmitted and pressed into the anti-microbial layer and the surface of the inner core layer (e.g., to a depth of 1-2 mm or more) for a permanent image.

Anti-microbial surface layer: The outer anti-microbial layer of the example embodiments can be comprised of a woven or welded or mechanically stretched metal or fabric mesh such as comprising silver, copper, bamboo or hemp formed into a sheet for this layer. For example, the outer shell may utilize a copper or silver mesh having a standard mesh count of 100×100, pitch at 0.010″(0.254 mm) with a wire diameter of 0.0045″ (0.114 3 mm) and total thickness of 0.009″ (0.2286 mm) with a plain weave. Bamboo or hemp fiber can be comprised of a simple plain weave to form the layer. Each material has its own distinctive antimicrobial properties that kill pathogens through direct contact by means of ionization of the cell membrane and/or chemical breakdown of the pathogen's cellular structure. Hence, combinations of these materials might also be utilized to attack a wider spectrum of microbes more effectively. For example, a hemp or bamboo layer may be used under a metallic screen layer, thereby comprising two distinct layers in this outer layer. Note that the design exposes this outer layer to the air in order to directly contact microbes that travel in the air currents.

Inner core layer: The inner core layer of the example embodiments can be made of urethane or polystyrene foam which may be chemically treated with an anti-microbial agent such as phenols, alcohols, halogens, oxidizing agents, surfactants and/or heavy metals depending on its environmental application. The foam core may be treated with specific anti-microbial agents to address specific outbreaks or commonality of certain airborne contagions. The foam might also be treated with fire proofing materials to reduce the combustibility of the layer(s). This layer may be provided thicker as desired to provide desired sound absorption properties, and it can be decoratively colored or treated for pleasing aesthetics.

Rigid backing (structural layer): The structural layer that can be comprised of a chipboard or cardboard backing is provided to add strength and structure to the panel, and may be coated with a fire resistant chemical such as NX2 Flametec©, Coldfire© or Fireguard© so the panel may comply with governmental regulations for use in public spaces. Other types of backing such as wood, plastic, composites, metals, or other materials might also be used.

Frame part: an optional framing part or layer can be arranged as channel framing which can be composed of wood, metal, composite or polymer such as ABS plastic providing structural rigidity and used to hold the core materials together. This layer can be arranged in a decorative manner, and may help in the manufacture of the panels to hold the layers together while reducing or eliminating the need for adhesives or other connectors.

The panels can be formed into a single piece held together by non-toxic adhesive distributed by pressurized spray gun or brush, upholstery staple fasteners, and/or commercially available chemical polymers to form a single unit panel that is easily transported and installed. The outer framing part, when utilized, acts as shell layer that is configured to encapsulate the urethane core and the backing, and which provides rigidity and mounting ability and eases installation with common wall hanging devices on the market. The panels can be hand assembled using a jig starting with the outer layer, forming the inset form and in-setting the foam and backing on top, with the layers be glued or otherwise fastened together. The assembly can be automated given the uniform diameters of the product.

Although the example embodiments show three or four layers of material, any of these layers might be duplicated as desired, or additional layers added, to provide additional desirable properties. In some cases, layers may not be needed, in particular the rigid backing may be avoided where the other layers add sufficient structure or where weight reduction is of prime importance, such as in ceiling installations.

Details of the Invention Operation/Functions: The panel acts as a static device that kills upon contact various airborne viruses and bacteria and other microbes. The panel requires no electricity and little to no maintenance besides routine cleaning. Removal of oxidation using a chemical agent may occasionally be performed to maximize the anti-microbial features if corrosion occurs over time, especially in the use of a copper-based material, which may be prone to some oxidation over a long time period.

Unique Features of Invention: The anti-microbial device (e.g., panel) is unique to the market in that it requires little to no expertise for installation and requires no power source. The panel or tile can be installed using a typical picture hanging wire and hook system, or by use of fasteners such as nails or screws or staples or rivets, or hook and loop double sided tape for example. The panels may have pre-cut holes in the back in which to attach picture hanging wire or placing upon hooks.

Example tiles/panels can also be placed in any standard sized suspended ceiling, or to panel entire walls. The device does not “capture” airborne viruses and bacteria; rather, it kills them on contact within a certain timeframe dependent upon the virility of the specific virus or bacteria. Effectiveness of the panels or tile may be dependent on the air circulation within a given space, with better circulation providing better results. Paradoxically, the more people or animals in a given space, the higher the air circulation and effectiveness of the panel. Sound absorbing qualities of the panel may be dependent upon the number of panels in a given space, in which case adding more panels to increase the panel density may improve the action of the panels in the room(s). Estimated ambient sound reduction, where provided, can be between 5-10 decibels, but could be increased using special designs for the sound absorption layer(s) or different, better sound absorbing materials.

Preferred Manufacturing Method: The example panels are a multi part device using a simple nontoxic adhesive application and manual manipulation of the material. The device assembly can be automated due to the simplicity and handle-ability and uniformity of the individual components. Standard sizes offered can be at 24×24 inch square panel as well as a 24×48 inch rectangular panel, 12×24 inch smaller panel, or other desirable sizes. The panels can be made approximately 1 to 1½ inch thick, but other sizes, shapes, and thicknesses could be provided. The panels can be constructed by laying the outer layer into a jig and pre forming a “box” or indentation for the subsequent layers. The foam is then inserted into the pre formed box and the chipboard is then adhered upon the foam. The entire panel core can then be e glued together attaching the extra material from the outer layer to the chipboard backing. Lastly the inner core material can be given added structural stability by “framing” the core with a channel framing part that is attached using adhesives, staples, welding or other chemical polymers. Given the uniformity of the panel pieces, this process can be automated.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. An anti-microbial panel comprising:
a structural layer; and
an anti-microbial layer, wherein
said structural layer and said anti-microbial layer are formed into a panel; and wherein
said panel is configured to the installed on a wall or ceiling of a room with the anti-microbial layer exposed to an interior of the room and the structural layer affixed to the wall or ceiling.

2. The panel of claim 1, further comprising a frame part configured to encompass the perimeter of the panel.

3. The panel of claim 2, further comprising an inner core layer provided between the structural layer and the anti-microbial layer.

4. The panel of claim 3, wherein said inner core layer is comprised of a urethane or polystyrene foam.

5. The panel of claim 4, wherein said anti-microbial layer is comprised of an uncoated copper screen.

6. The panel of claim 1, further comprising an inner core layer provided between the structural layer and the anti-microbial layer.

7. The panel of claim 6, wherein said anti-microbial layer, said inner core layer, and said structural layer are laminated together using a glue or fastener to connect the layers together.

8. The panel of claim 6, wherein said inner core layer is comprised of a urethane or polystyrene foam.

9. The panel of claim 8, wherein said anti-microbial layer is comprised of an uncoated copper screen.

10. The panel of claim 1, wherein said anti-microbial layer is comprised of an uncoated copper screen.

11. The panel of claim 1, wherein at least said anti-microbial layer is embossed with an image.

12. An anti-microbial panel comprising:
a structural layer;
an inner core layer comprised of a lightweight polymer affixed to the structural layer;
an anti-microbial layer affixed to the inner core layer; and
a frame part, wherein
said structural layer, said inner core layer, and said anti-microbial layer are formed into a panel; and wherein
said frame part is configured to encompass the perimeter of the panel; and further wherein
said panel is configured to the installed on a wall or ceiling of a room with the anti-microbial layer exposed to an interior of the room and the structural layer affixed to the wall or ceiling.

13. The panel of claim 12, wherein said anti-microbial layer is comprised of an uncoated copper screen.

14. The panel of claim 13, wherein said anti-microbial layer is embossed with an image.

15. The panel of claim 12, wherein said inner core layer is comprised of a urethane or polystyrene foam.

16. The panel of claim 12, wherein at least said anti-microbial layer is embossed with an image.

17. The panel of claim 12, wherein said anti-microbial layer, said inner core layer, and said structural layer are laminated together using a glue or fastener to connect the layers together.

18. A method of killing microbes in a room comprising the steps of:
providing an anti-microbial panel comprising:
a structural layer,
an inner core layer comprised of a lightweight polymer affixed to the structural layer, and
an anti-microbial layer affixed to the inner core layer, wherein
said structural layer, said inner core layer, and said anti-microbial layer are formed into a panel;
installing a plurality of said panels in a room on a wall, a ceiling, or both; and
killing microbes in the room when said microbes come into contact said anti-microbial layer through air flow in the room.

19. The method of claim 18, wherein said anti-microbial layer is comprised of an uncoated copper screen.

20. The method of claim 19, wherein said inner core layer is comprised of a urethane or polystyrene foam.

21. The method of claim 19, said panel further comprising a frame part configured to encompass the perimeter of the panel.

22. The method of claim 18, wherein at least said anti-microbial layer is embossed with an image.

23. The method of claim 18 said panel further comprising a frame part configured to encompass the perimeter of the panel.
